(19) United States
(12) Patent Application Publication
(10) Pub. No.: US 2012/0208075 A1
(43) Pub. Date: Aug. 16, 2012

(54) Secondary Battery

(75) Inventor: Byungho Lim, Yongin-si (KR)

(73) Assignee: SAMSUNG SDI CO., LTD., Yongin-si (KR)

(21) Appl. No.: 13/239,921

(22) Filed: Sep. 22, 2011

(30) Foreign Application Priority Data
Feb. 16, 2011 (KR) 10-2011-0013651

(51) Int. Cl. H01M 2/06; H01M 2/30

(52) U.S. Cl. 429/179

(57) ABSTRACT

A rechargeable battery including a rupturable cap plate to prevent short-circuiting between an electrode assembly and the electrode terminal when a compressive force is applied. The rechargeable battery includes an electrode assembly having first and second electrode plates with a separator interposed therebetween, a can accommodating the electrode assembly and having a top opening, an electrode terminal electrically connected to the electrode assembly, and a cap plate sealing the top opening of the can and exposing the electrode terminal to the outside. At least two grooves are formed on a bottom surface of the cap plate, on either side of the electrode terminal.

### CLAIM OF PRIORITY

This application makes reference to, incorporates the same herein, and claims all benefits accruing under 35 U.S.C. §119 from an application earlier filed in the Korean Intellectual Property Office on the 16 Feb. 2011 and there duly assigned Ser. No. 10-2011-0013651.

### BACKGROUND OF THE INVENTION

1. Field of the Invention

The present invention relate to a secondary battery, and more particularly to a secondary battery capable of preventing a short circuit when deformed by a compressive force.

2. Description of the Related Art

A rechargeable, secondary battery may be charged and discharged unlike a primary battery that may not be recharged. A low capacity rechargeable battery that comprises a pack shaped battery cell may be used as a power source for various small portable electronic devices such as cellular phones, or camcorders.

Generally, secondary batteries use a lithium-based oxide as a first electrode active material and a carbon material as a second electrode active material. Further, the secondary batteries have been manufactured in various shapes, e.g., cylindrical can types, rectangular or prismatic can types, pouch types, etc. and may comprise an electrode assembly housed in a can and a cap assembly sealing a top portion of the can.

The cap assembly comprises a cap plate that is attached to the top portion of the can. The cap plate includes a terminal through-hole, a gasket placed on the outer surface of the terminal through-hole to be electrically insulated from the cap plate, and an insulation plate that is positioned under the cap plate. The insulation plate includes a terminal plate to be electrically connected to the electrode terminal. One electrode of the electrode assembly is electrically connected with the electrode terminal through an electrode tab and the terminal plate. Another electrode is electrically connected with either the cap plate or the can through an electrode tab.

When a compressive force is applied to the rechargeable battery, the cap plate may irregularly deform to cause the electrode assembly and the cap plate to contact each other, resulting in short-circuiting therebetween.

### SUMMARY OF THE INVENTION

The present invention provides a rechargeable battery including a cap plate having at least two grooves around an electrode terminal, thereby preventing short-circuiting between an electrode assembly and the electrode terminal due to a contact between the cap plate and the electrode terminal of different polarities when a compressive force is applied.

According to an embodiment of the present invention, a rechargeable battery may be constructed with an electrode assembly having first and second electrode plates with a separator interposed between the first and second electrode plates; a can accommodating the electrode assembly and having a top opening; an electrode terminal electrically connected to the electrode assembly; a cap plate sealing the top opening of the can and exposing the electrode terminal to the outside; and at least two grooves formed on a bottom surface of the cap plate on either side of the electrode terminal.

The grooves may transverse the shorter width of the cap plate.

When a compressive force is applied to the cap plate, the electrode terminal may deform outwardly with respect to the electrode assembly.

The cap plate may be ruptured along grooves.

The grooves may be formed to a depth of 10% to 75% of a thickness of the cap plate.

The grooves may have a rectangular, triangular or arcuated shape.

At least two auxiliary grooves may be formed on a top surface of the cap plate on either side of the electrode terminal.

The at least two auxiliary grooves formed on the top surface of the cap plate have a depth shallower than a depth of the at least two grooves formed on the bottom surface of the cap plate.

The first electrode plate may be electrically connected to the cap plate and the second electrode plate may be electrically connected to the electrode terminal.

According to another embodiment of the present invention, a rechargeable battery may be constructed with an electrode assembly having first and second electrode plates with a separator interposed therebetween, a can accommodating the electrode assembly and having a top opening, an electrode terminal electrically connected to the electrode assembly, and a cap plate sealing the top opening of the can and exposing the electrode terminal to the outside; and at least two main grooves formed on a bottom surface of the cap plate on either side of the electrode terminal and at least two auxiliary grooves corresponding to the main grooves formed on a top surface of the cap plate.

The main grooves may have depths greater than those of the auxiliary grooves.

The cap plate may rupture along the main and auxiliary grooves and the electrode terminal may deform outwardly with respect to an electrode assembly, when a compressive force is applied to the can.

The main and auxiliary grooves transverse the cap plate.

As described above, since the rechargeable battery contemplates a cap plate having at least two grooves on either side of an electrode terminal, it is possible to prevent short-circuiting between an electrode assembly and the electrode terminal, due to a contact between the cap plate and the electrode terminal of different polarities, when a compressive force is applied.

In addition, in the rechargeable battery according to the embodiment of the present invention, when a compressive force is applied, the electrode terminal deforms outwardly with respect to the battery, thereby prevent short-circuiting and ultimately improving the safety of the battery.

Additional aspects and/or advantages of the invention will be set forth in part in the description which follows and, in part, will be obvious from the description, or may be learned by practice of the invention.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is an exploded assembly view of a rechargeable battery constructed as an embodiment of the present invention;

FIG. 2 is a lower plan view illustrating installation of a cap assembly shown in FIG. 1;

FIG. 3 is a perspective view of the cap assembly shown in FIG. 2;

FIG. 4 is an exploded side view of the cap assembly and a second electrode tab shown in FIG. 1;

FIG. 5A is a perspective view illustrating a compressive force test performed on the rechargeable battery shown in FIG. 1;

FIG. 5B is a perspective view illustrating a ruptured cap plate after removal of an insulation case from the rechargeable battery shown in FIG. 5A;

FIG. 5C is a perspective view illustrating damage suffered by a top portion of the rechargeable battery shown in FIG. 5B;

FIG. 6 is an exploded side view illustrating a rectangular groove of a cap plate according to another embodiment of the present invention;

FIG. 7 is an exploded side view illustrating an arcuated groove of a cap plate according to still another embodiment of the present invention; and

FIG. 8 is an exploded side view illustrating main grooves and auxiliary grooves of the cap plate.

### DETAILED DESCRIPTION OF THE INVENTION

Hereinafter, examples of embodiments of the invention will be described in detail with reference to the accompanying drawings such that they can easily be made and used by those skilled in the art. In the following description and accompanying drawings, like reference numerals are used to designate like components in order to omit repetitive descriptions of same or similar components. Further, when it is stated herein that one part is “connected” to another part, the one part may be directly connected to the other part, or the one part and the other part maybe electrically connected at respective sides of another device or conductive element.

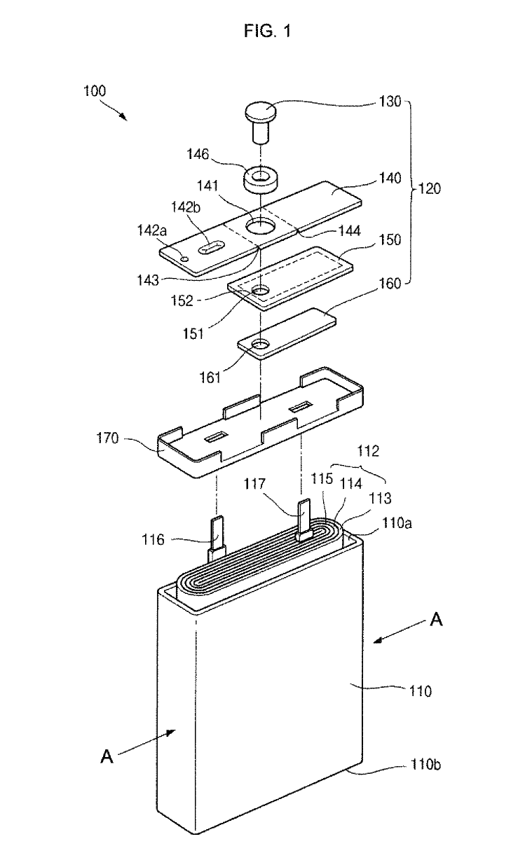

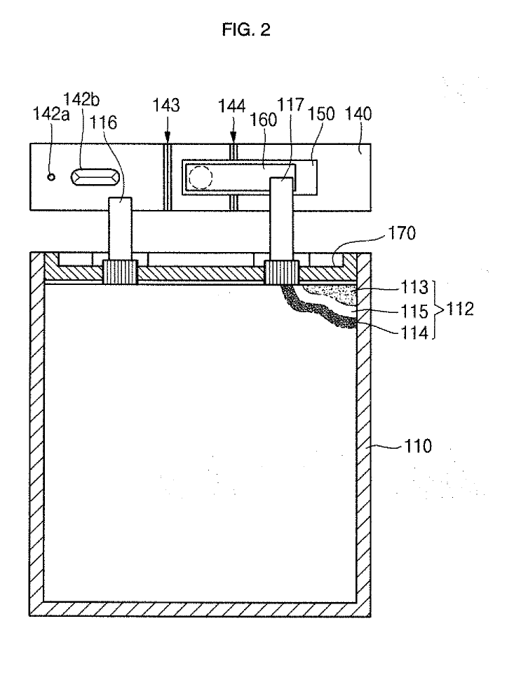

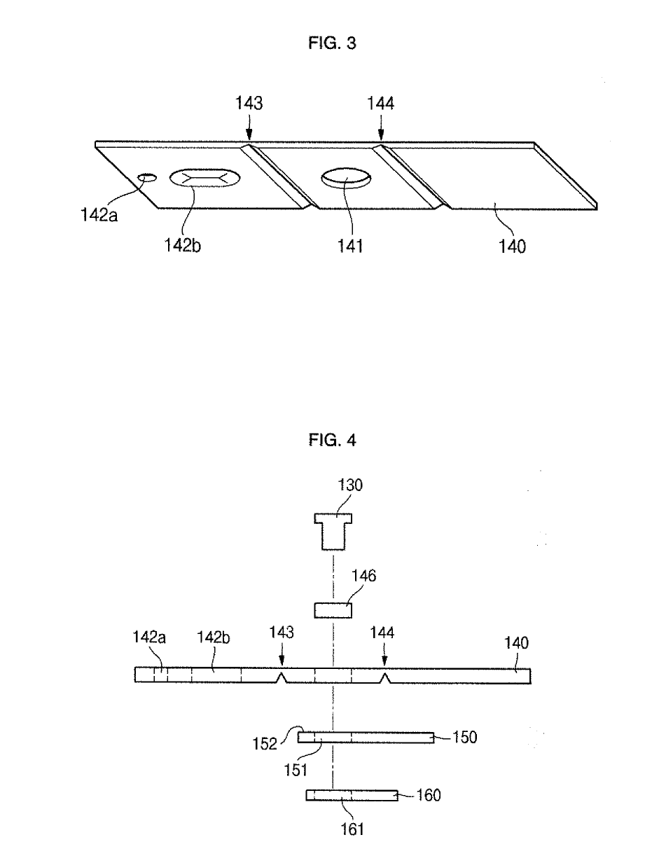

FIG. 1 is an exploded perspective view of a rechargeable battery according to an embodiment of the present invention, FIG. 2 is a lower plan view of a cap assembly shown in FIG. 1, FIG. 3 is a perspective view of the cap assembly shown in FIG. 2, and FIG. 4 is a side view of the cap assembly and a second electrode tab shown in FIG. 1.

Referring to FIGS. 1 to 4, the rechargeable battery 100 according to the embodiment of the present invention includes a can 110, an electrode assembly 112, a cap assembly 120 and an insulation case 170.

In the rechargeable battery 100, the electrode assembly 112, including a first electrode plate 113, a second electrode plate 115 and a separator 114, is housed in the can 110 together with an electrolyte, and a top opening 110a of the can 110 is sealed with the cap assembly 120.

The cap assembly 120 includes a cap plate 140. The cap plate 140 includes two grooves 143 and 144 formed on its bottom surface. The grooves 143 and 144 include at least two formed on either side of a terminal through-hole 141 for an electrode terminal 130. When a compressive force A is applied to can 110 for rechargeable battery 100, the grooves 143 and 144 are ruptured to cause cap plate 140 deform. In this case, the electrode terminal 130 protrudes outwardly with respect to the rechargeable battery 100, thereby preventing short-circuiting between the electrode terminal 130 and the electrode assembly 112, which would otherwise likely occur had either cap plate 140 been forced inwardly into physical contact with electrode assembly 112, or if electrode terminal 130 had been confined and forced into physical contact with an electrical conductor at an opposite polarity.

The grooves 143 and 144 have a triangular shape and are formed on the bottom surface of the cap plate 140. The grooves 143 and 144 are formed perpendicular to the long sides of the cap plate 140. In this case, the grooves 143 and 144 are ruptured when a compressive force A is applied to the rechargeable battery 100. The grooves 143 and 144 are formed to a depth of 10% to 75% of a thickness of the cap plate 140. The grooves 143 and 144 have depths provided so as to be ruptured by the compressive force , but the invention is not limited to the depth illustrated herein.

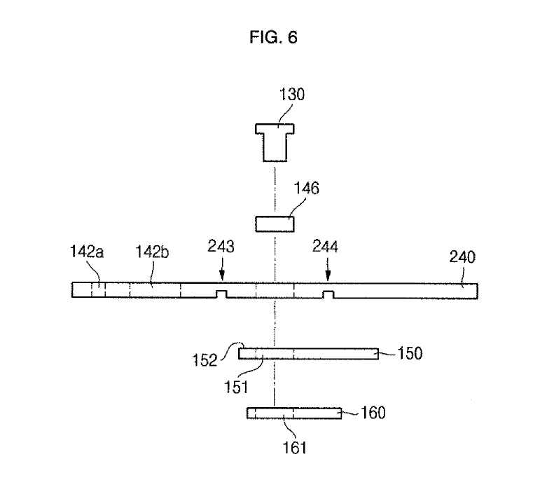

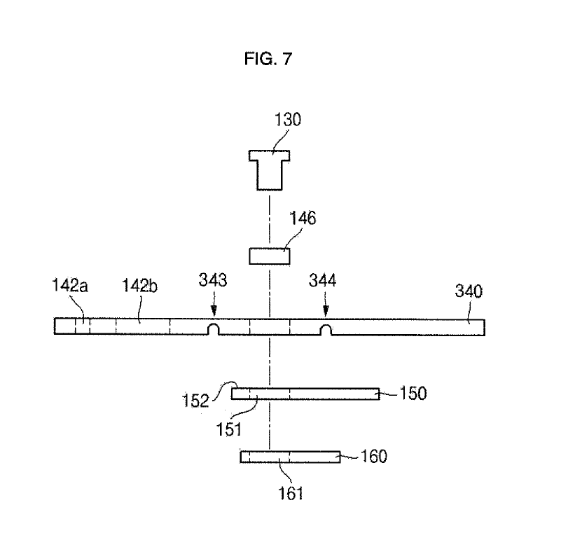

The grooves may have various shapes, and the invention does not limit the shapes of illustrated grooves 143 and 144. As shown in FIG. 6, the grooves 243 and 244 formed on the bottom surface of the cap plate 240 may have a rectangular shape, or as shown in FIG. 7, the grooves 343 and 344 formed on the bottom surface of the cap plate 340 may have an arcuated shape.

Referring again to FIG. 1, the can 110 is generally made of a metal such as aluminum or an aluminum alloy, by a deep drawing process. In general, a bottom surface 110b of the can 110 is substantially planar. The can 110 is made of a metal and may serve as a terminal itself. A top portion of the can 110 has a top opening 110a. The electrode assembly 112 is housed in the can 110 through the top opening 110a.

The electrode assembly 112 is formed by winding, in a jelly-roll style, a stack of the first electrode plate 113, the separator 114 and the second electrode plate 115, respectively. A first electrode tab 116 is coupled to the first electrode plate 113 to then protrude toward insulation case 170. A second electrode tab 117 is coupled to the second electrode plate 115 to then protrude toward insulation case 170. In the electrode assembly 112, the first electrode tab 116 and the second electrode tab 117 are spaced apart from each other and electrically insulated from each other. The first electrode plate 113 and the second electrode plate 115 of the electrode assembly 112 may be reversed according to the configuration of the rechargeable battery.

The cap assembly 120 includes a cap plate 140, an insulation plate 150, a terminal plate 160 and an electrode terminal 130. The cap assembly 120 is coupled to the separate insulation case 170 to then be connected to the top opening 110a of the can 110 to seal the can 110.

The cap plate 140 is formed of a metal plate sized and shaped to fit the top opening 110a of the can 110. A terminal through-hole 141 having a predetermined size is formed at the center of the cap plate 140. A gasket tube 146 is inserted into the terminal through-hole 141 and the electrode terminal 130 is inserted through gasket tube 146. At least two grooves 143 and 144 are formed in cap plate 140 on either side of the terminal through-hole 141.

When the electrode terminal 130 is inserted into a terminal through-hole 141, which will later be described, the tubular gasket tube 146 engaged with the outer surface of the electrode terminal 130 is also inserted between cap plate 140 and electrode terminal 130, beneath the head and along the shaft of electrode terminal 130 in order to insulate the electrode terminal 130 from physical and electrical contact with cap plate 140. The electrode terminal 130 is connected to the second electrode tab 117 (as is described below) of the second electrode plate 115 (or the first electrode tab 116 of the first electrode plate 113) to serve as a second electrode terminal (or a first electrode terminal).

The cap plate 140 has an electrolyte injection hole 142a. An electrolyte is injected through the electrolyte injection hole 142a and the electrolyte injection hole 142a is sealed by a separate sealing means (not shown). In addition, the cap plate 140 includes a safety vent 142b that releases gas because it is thin and is ruptured at a predetermined pressure.

The insulation plate 150 is made of an insulation material that is the same as the gasket tube 146, and is coupled to the bottom portion of the cap plate 140. The insulation plate 150 includes a terminal through-hole 151 into which the electrode terminal 130 is inserted, the terminal through-hole 151 is located to corresponding to the terminal through-hole 141 of the cap plate 140. A mounting groove 152 sized to fit the terminal plate 160 is formed on the bottom surface of the insulation plate 150, so that the terminal plate 160 is mounted.

The terminal plate 160 is generally made of an electrically conducting metal such as a nickel (Ni) alloy, and is mounted on the bottom surface of the insulation plate 150, but the material of the terminal plate 160 is not limited thereto. The terminal plate 160 includes a terminal through-hole 161 into which the electrode terminal 130 is inserted, terminal through-hole 161 located to corresponding to the terminal through-hole 141 of the cap plate 140. Since the electrode terminal 130 is insulated by the gasket tube 146 and is coupled through the terminal through-hole 141 of the cap plate 140, the terminal plate 160 is electrically insulated from the cap plate 140 and is electrically connected to the electrode terminal 130.

Second electrode tab 117 coupled to the second electrode plate 115 is welded to one side of the terminal plate 160. In addition, a first electrode tab 116 coupled to the first electrode plate 113 is welded to one bottom surface of the cap plate 140. The electrode terminal 130 and the cap plate 140 have different polarities. The second electrode tab 117 and the first electrode tab 116 are coupled by, for example, resistance welding or laser welding. Specifically, the second electrode tab 117 and the first electrode tab 116 are generally welded by resistance welding.

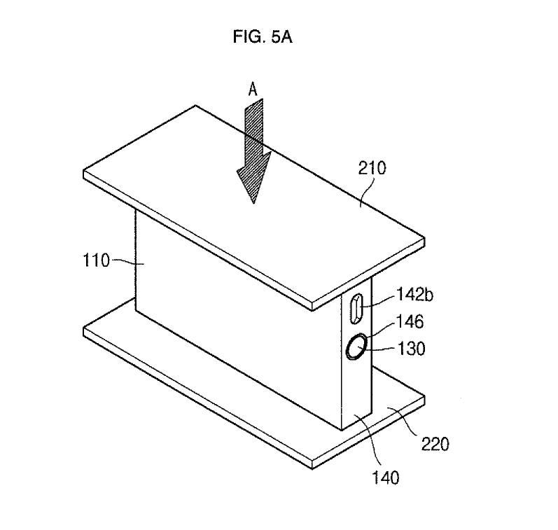

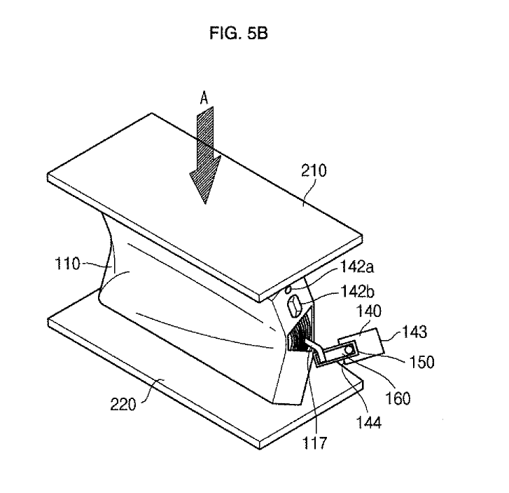

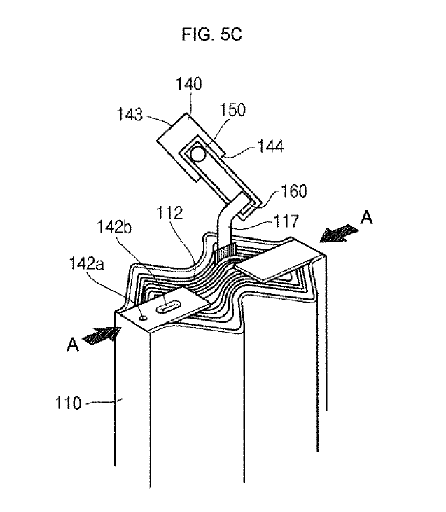

FIG. 5A is a perspective view illustrating a compressive force test performed on the rechargeable battery shown in FIG. 1, FIG. 5B is a perspective view illustrating a ruptured cap plate, after removing insulation case 170 from the rechargeable battery shown in FIG. 5A for illustrative purposes, and FIG. 5C is a perspective view illustrating a top portion of a crushed rechargeable battery shown in FIG. 5B (sans insulation case 170). Insulation case 170 is fabricated from an electrically insulating material. Consequently, in the event that a vertically compressive is accidentally applied to the rechargeable battery, the insulation case may be irregularly deformed, but will not create an electrically short circuit.

As shown in FIG. 5A, the rechargeable battery 100 is set between two compression plates 210 and 220 and a compressive force A of 13 kilo-Newtons (i.e., 13 kN) is applied thereto. With the compressive force A applied thereto, the rechargeable battery 100 may deform, as shown in FIGS. 5B and 5C. In this case, the rechargeable battery 100 deforms in its top, side and bottom surfaces. The cap plate 140 is disposed at a top portion of the deformed rechargeable battery 100, and the can 110 is disposed on the side and bottom surfaces of the rechargeable battery 100. The cap plate 140 includes an electrode terminal 130 insulated by a gasket tube 146 and is liable to deform due to deformation. The cap plate 140 is ruptured along the grooves 143 and 144 formed around the electrode terminal 130 to be divided into at least three units. The electrode terminal 130 positioned between the two grooves 143 and 144 protrudes outside the rechargeable battery 100, as shown in FIGS. 5B and 5C. Since the cap plate 140 is ruptured in a predetermined pattern, short-circuiting can be prevented.

It may be noted that although the impact applied to rechargeable battery 100 is applied along the direction illustrated by arrows A that are substantially normal to the planes of the sidewalls of case 110 in the foregoing tests, in everyday use impacts may be applied to case 110 from any direction.

Next, a cap plate 440 of the rechargeable battery which may be constructed as another embodiment of the present invention will be described.

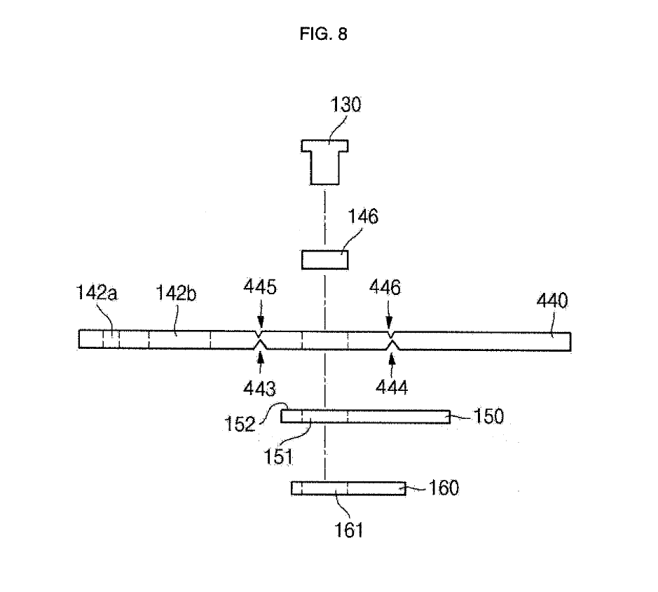

FIG. 8 is an exploded side view, similar to FIGS. 4, 6 and 7, illustrating main grooves and auxiliary grooves of the cap plate.

The cap plate 440 of the rechargeable battery according to the embodiment of the present invention is substantially the same as the cap plate 140 shown in FIGS. 2 and 4 in view of configuration and function, except for configurations of grooves. Accordingly, repeated descriptions of the same components will not be given and the cap plate 440 of the rechargeable battery according to the embodiment of the present invention will be described with regard to the main grooves 443 and 444 and the auxiliary grooves 445 and 446.

At least two of the main grooves 443 and 444 are formed on the bottom surface of the cap plate 440 around the electrode terminal 130. The auxiliary grooves 445 and 446 are formed on the top surface of the cap plate 440 to correspond to the main grooves 443 and 444. In this case, the main grooves 443 and 444 have depths greater than those of the auxiliary grooves 445 and 446.

The main grooves 443 and 444 and the auxiliary grooves 445 and 446 are ruptured when a compressive force is applied to the rechargeable battery. Since portions where the main grooves 443 and 444 and the auxiliary grooves 445 and 446 are formed are thinner than a portion where the cap plate 440 is formed, the main grooves 443 and 444 and the auxiliary grooves 445 and 446 are ruptured when a compressive force is applied to the rechargeable battery.

The electrode terminal 130 may be positioned between the two of the main grooves 443 and 444. As shown in FIG. 5B, when an impact that creates a compressive force which is applied a part of rechargeable battery 100, such as the sidewall of case 110, as the compressive force is applied to the rechargeable battery 100, the cap plate 440 is ruptured to deform, or break outwardly along the main grooves 443 and 444 and the auxiliary grooves 445 and 446, so that the electrode terminal 130 protrudes outwardly. Since the cap plate 440 is ruptured in a predetermined pattern, and the constituent parts of the cap assembly, such as the electrically conductive cap plate 440 are forced outwardly and away from the electrode assembly that is housed within the interior of the case, a deleterious failure which may otherwise result from the impact, such as short-circuiting, which could occur if an electrically conductive member such as cap plate 440 would have been forced by the impact into the electrode assembly, can be prevented.

The foregoing paragraphs describe some of the aspects and features for a rechargeable battery that may be constructed according to the principles of the present invention with an electrode assembly having first and second electrode plates with a separator interposed between the first and second electrode plates, a can encasing the electrode assembly, an electrode terminal electrically connected to the electrode assembly, a cap plate sealing a top opening of the can, and at least two grooves formed on a bottom surface of the cap plate on either side of the electrode terminal. The grooves may be formed transversely to the width of the major surface of the cap plate, so that in response to the force created by an impact applied to the exterior of the rechargeable batter, the electrode terminal will be cause to deform outwardly and away from to the core of the electrode assembly.

Alternatively, a rechargeable battery may be constructed according to the principles of the present invention with an electrode assembly inserted through a top opening of a can configured to encase the electrode assembly, an electrode terminal electrically connected to the electrode assembly, a cap plate sealing the top opening of the can, and at least two main grooves formed on a bottom surface of the cap plate on either side of the electrode terminal and at least two auxiliary grooves corresponding to the main grooves formed on a top surface of the cap plate. The main grooves may be formed to be deeper into the thickness bottom surface of the cap plate than the auxiliary grooves, with the main and auxiliary grooves transversing the width of the cap plate. When a compressive force such as created by an accidental impact, is applied to the can, cap plate will be caused to rupture along the main and auxiliary grooves and the electrode terminal to deform outwardly from the cap assembly, and away from a physical engagement with the electrode assembly.

The grooves may be formed, molded or cut to have a rectangular, triangular or arcuate cross-sectional shape, and the grooves may be formed to a depth within a range extending from 10% to 75% of a thickness of the cap plate. At least two auxiliary grooves may be formed on a top surface of the cap plate on either side of the electrode terminal.

While this invention has been described in connection with what is presently considered to be practical exemplary embodiments, it is to be understood that the invention is not limited to the disclosed embodiments, but, rather is intended to cover various modifications and equivalent arrangements included within the spirit and scope of the appended claims.

What is claimed is:

1. A rechargeable battery, comprising:
an electrode assembly having first and second electrode plates with a separator interposed therebetween;
a can accommodating the electrode assembly and having a top opening;
an electrode terminal electrically connected to the electrode assembly;
a cap plate sealing the top opening of the can and exposing the electrode terminal to the outside; and
at least two grooves formed on a bottom surface of the cap plate on either side of the electrode terminal.

2. The rechargeable battery of claim 1, wherein the grooves transverse the cap plate.

3. The rechargeable battery of claim 1, wherein the electrode terminal deforms outwardly with respect to the electrode assembly, when a compressive force is applied to the can.

4. The rechargeable battery of claim 3, wherein the cap plate is ruptured along the grooves.

5. The rechargeable battery of claim 1, wherein the grooves are formed to a depth of 10% to 75% of a thickness of the cap plate.

6. The rechargeable battery of claim 1, wherein the grooves have a rectangular, triangular or arcuated shape.

7. The rechargeable battery of claim 1, further comprising at least two auxiliary grooves formed on a top surface of the cap plate on either side of the electrode terminal.

8. The rechargeable battery of claim 1, wherein the at least two auxiliary grooves formed on the top surface of the cap plate have a depth shallower than a depth of the at least two grooves formed on the bottom surface of the cap plate.

9. The rechargeable battery of claim 1, wherein the first electrode plate is electrically connected to the cap plate and the second electrode plate is electrically connected to the electrode terminal.

10. A rechargeable battery, comprising:
an electrode assembly having first and second electrode plates with a separator interposed therebetween;
a can accommodating the electrode assembly and having a top opening;
an electrode terminal electrically connected to the electrode assembly;
a cap plate sealing the top opening of the can and exposing the electrode terminal to the outside; and
at least two main grooves formed on a bottom surface of the cap plate on either side of the electrode terminal and at least two auxiliary grooves corresponding to the main grooves formed on a top surface of the cap plate.

11. The rechargeable battery of claim 10, wherein the main grooves are deeper than the auxiliary grooves.

12. The rechargeable battery of claim 10, wherein cap plate ruptures along the main and auxiliary grooves and the electrode terminal deforms outwardly with respect to the electrode assembly, when a compressive force is applied to the can.

13. The rechargeable battery of claim 10, wherein the main and auxiliary grooves transverse the cap plate.
